(19) United States
(12) Patent Application Publication
(10) Pub. No.: US 2023/0415982 A1
(43) Pub. Date: Dec. 28, 2023

(54) REFUSE VEHICLE LIFT ASSEMBLY WITH CLOSED-LOOP CONTROL

(71) Applicant: Oshkosh Corporation, Oshkosh, WI (US)

(72) Inventors: Amanda Miller, Oshkosh, WI (US); Christopher Rukas, Oshkosh, WI (US); Greg Steffens, Oshkosh, WI (US); Aaron Fisher, Oshkosh, WI (US); Ryan Wolf, Oshkosh, WI (US); Jeff Verhagen, Oshkosh, WI (US)

(73) Assignee: Oshkosh Corporation, Oshkosh, WI (US)

(21) Appl. No.: 18/214,852

(22) Filed: Jun. 27, 2023

Related U.S. Application Data
(60) Provisional application No. 63/356,155, filed on Jun. 28, 2022.

(51) Int. Cl. B65F 3/04

(52) U.S. Cl. CPC B65F 3/04; B65F 2003/0279

(57) ABSTRACT

A refuse vehicle includes a chassis, a body coupled to the chassis and configured to store a volume of refuse, a lift assembly, and a controller. The lift assembly includes a track coupled to the chassis, a track actuator configured to move the track relative to the chassis, a track position sensor configured to provide track position data indicating a position of the track relative to the chassis, a grabber coupled to the track and configured to engage a refuse container, a lift actuator configured to move the grabber relative to the track, and a grabber position sensor configured to provide grabber position data indicating a position of the grabber relative to the track. The controller is configured to control the track actuator and the lift actuator based on the grabber position data and the track position data.

### CROSS-REFERENCE TO RELATED PATENT APPLICATION

This application claims the benefit of and priority to U.S. Provisional Application No. 63/356,155, filed on Jun. 28, 2022, the entire disclosure of which is hereby incorporated by reference herein.

### BACKGROUND

The present disclosure relates generally to vehicles. More specifically, the present disclosure relates to a refuse vehicle including a lift assembly. Refuse vehicles utilize lift assemblies to lift and empty refuse containers. Throughout operation, the lift assembly can generate vibrations that provide an undesirable riding experience for an operator of the refuse vehicle.

### SUMMARY

One embodiment relates to a refuse vehicle including a chassis, a body coupled to the chassis and configured to store a volume of refuse, a lift assembly, and a controller. The lift assembly includes a track coupled to the chassis, a track actuator configured to move the track relative to the chassis, a track position sensor configured to provide track position data indicating a position of the track relative to the chassis, a grabber coupled to the track and configured to engage a refuse container, a lift actuator configured to move the grabber relative to the track, and a grabber position sensor configured to provide grabber position data indicating a position of the grabber relative to the track. The controller is operatively coupled to the track position sensor and the grabber position sensor. The controller is configured to control the track actuator and the lift actuator based on the grabber position data and the track position data.

Another embodiment relates to a method of controlling a refuse vehicle. The refuse vehicle includes a chassis, a track movably coupled to the chassis, and a grabber movably coupled to the track and configured to engage a refuse container. The method includes receiving, from a first sensor, track position data indicating a position of the track relative to the chassis, controlling a track actuator to move the track relative to the chassis based on the track position data, receiving, from a second sensor, grabber position data indicating a position of the grabber relative to the track, and controlling a lift actuator to move the grabber relative to the track based on the grabber position data.

Another embodiment relates to a refuse vehicle including a chassis, a body coupled to the chassis and configured to store a volume of refuse, a lift assembly, and a controller. The lift assembly includes a track coupled to the chassis, a track actuator configured to move the track relative to the chassis between an extended position and a retracted position, a track position sensor configured to provide track position data indicating a position of the track relative to the chassis, a grabber coupled to the track and configured to engage a refuse container, a lift actuator configured to move the grabber relative to the track between a lowered position and a raised position, and a grabber position sensor configured to provide grabber position data indicating a position of the grabber relative to the track. The controller is operatively coupled to the track position sensor and the grabber position sensor. The controller is configured to control the track actuator to reduce a speed of the track in response to a determination that the track is within a first threshold distance of the retracted position. The controller is configured to control the lift actuator to reduce a speed of the grabber in response to a determination that the track is within a second threshold distance of the raised position. The controller is configured to control the track actuator to bring the track to the retracted position and control the lift actuator to bring the grabber to the raised position at substantially the same time.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle.

FIG. 5 is a perspective view of the vehicle of FIG. 1 configured as a side-loading refuse vehicle, according to an exemplary embodiment.

FIG. 6 is a right side view of the side-loading refuse vehicle of FIG. 5.

FIG. 7 is a top view of the side-loading refuse vehicle of FIG. 5.

FIG. 8 is a left side view of the side-loading refuse vehicle of FIG. 5 configured with a tag axle.

FIG. 9 is a perspective view of the vehicle of FIG. 1 configured as a mixer vehicle, according to an exemplary embodiment.

FIG. 10 is a perspective view of the vehicle of FIG. 1 configured as a fire fighting vehicle, according to an exemplary embodiment.

FIG. 11 is a left side view of the vehicle of FIG. 1 configured as an airport fire fighting vehicle, according to an exemplary embodiment.

FIG. 12 is a perspective view of the vehicle of FIG. 1 configured as a boom lift, according to an exemplary embodiment.

FIG. 13 is a perspective view of the vehicle of FIG. 1 configured as a scissor lift, according to an exemplary embodiment.

FIGS. 14 and 15 are a front section views of the side-loading refuse vehicle of FIG. 5.

FIG. 16 is a block diagram of a control system for the side-loading refuse vehicle of FIG. 5, according to an exemplary embodiment.

FIG. 17 is a front view of a lift assembly of the side-loading refuse vehicle of FIG. 5.

FIGS. 18 and 19 are front detail views of the lift assembly of FIG. 17.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a lift assembly having a track and a grabber assembly that engages a refuse container. A track actuator moves the track relative to a chassis of the vehicle, and a lift actuator moves the grabber assembly along the track. A track position sensor provides track position data identifying a position of the track relative to the chassis. A grabber position sensor provides grabber position data identifying a position of the grabber assembly along the track. Using the grabber position data and the track position data to perform closed-loop position control, a controller varies the speed of the track actuator and the lift actuator and/or delays operation of the track actuator or the lift actuator to reduce vibrations caused by impacts of the lift assembly.

### Overall Vehicle

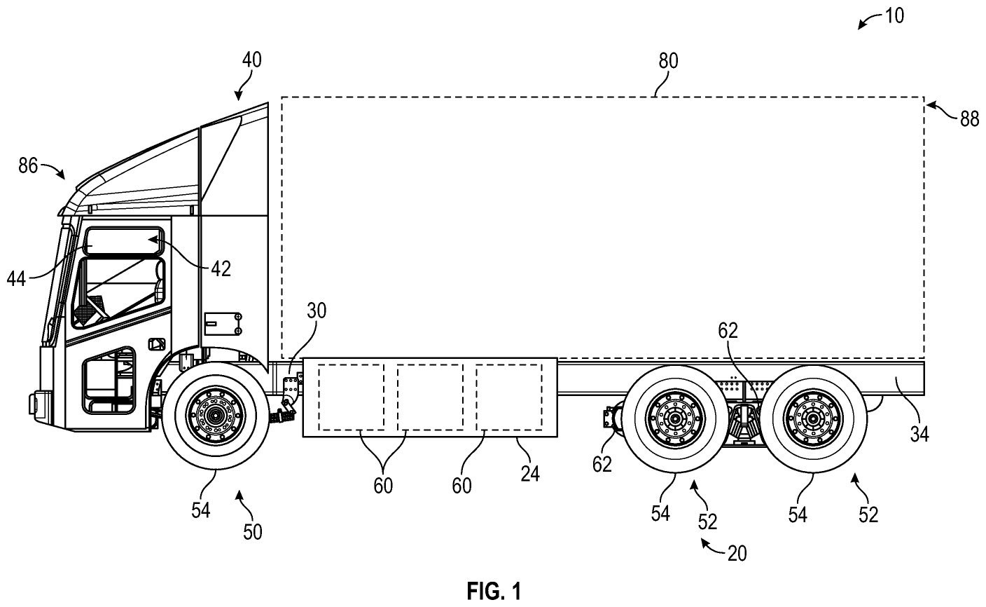

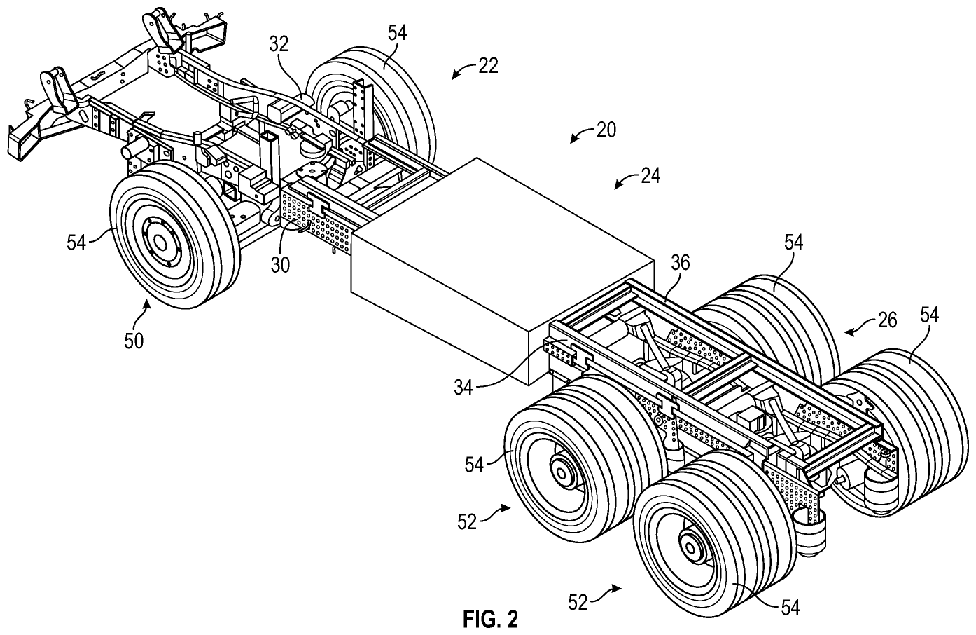

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

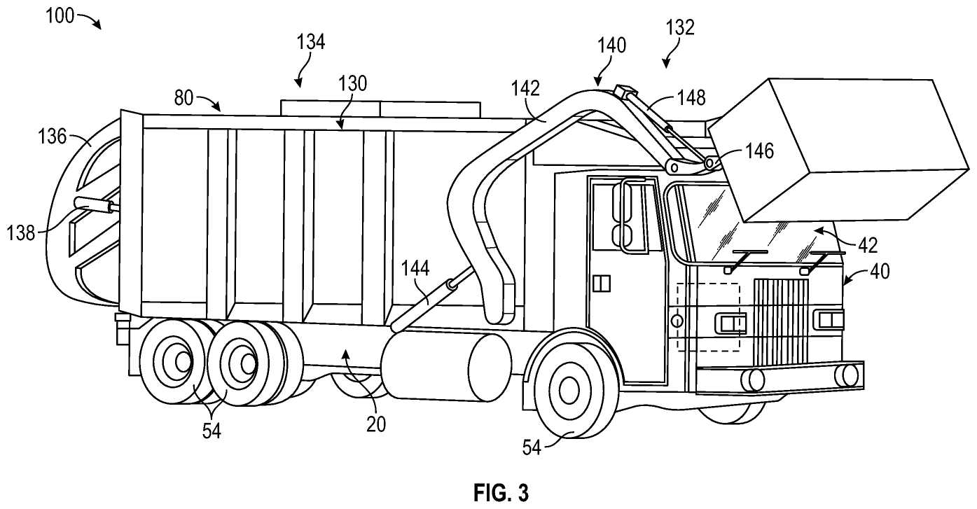

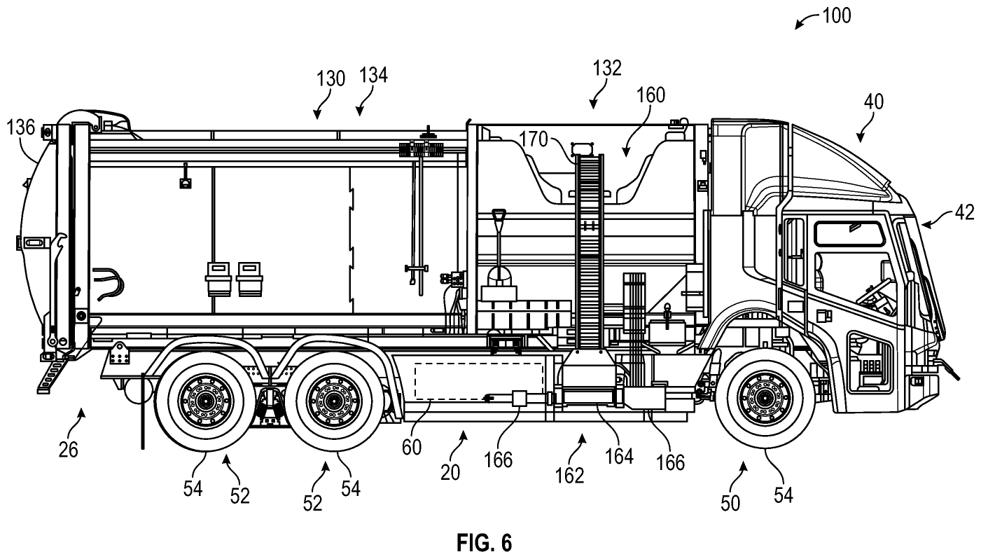

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-13 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### A. Front-Loading Refuse Vehicle

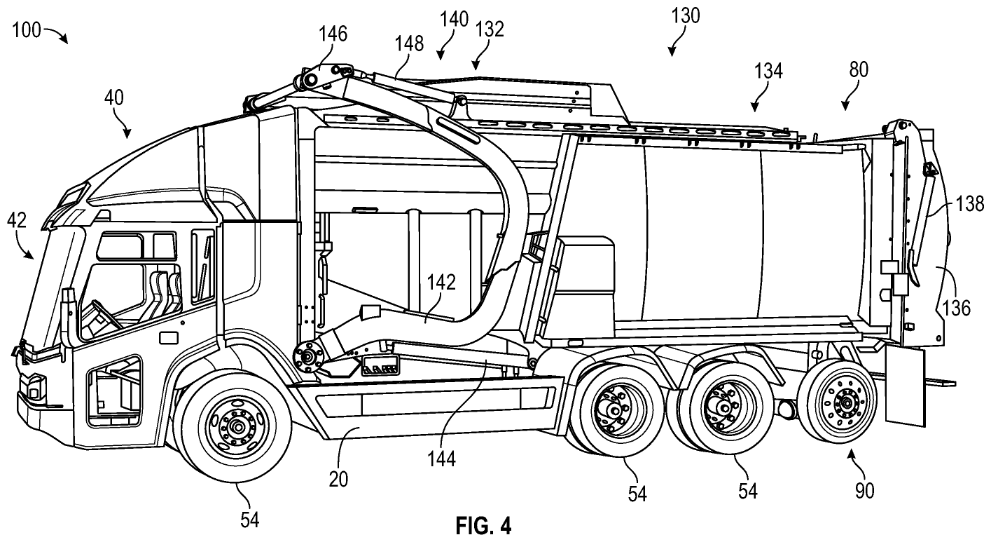

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### B. Side-Loading Refuse Vehicle

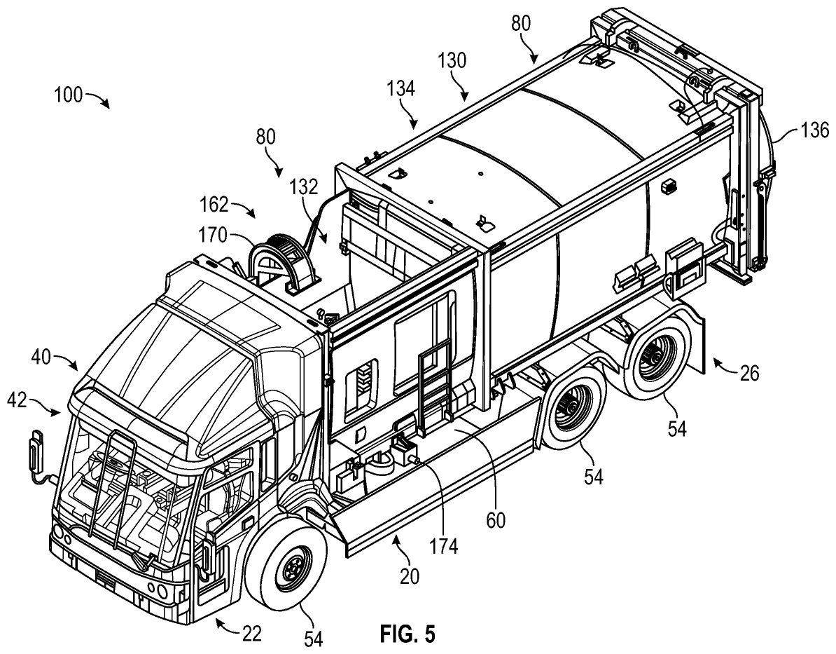

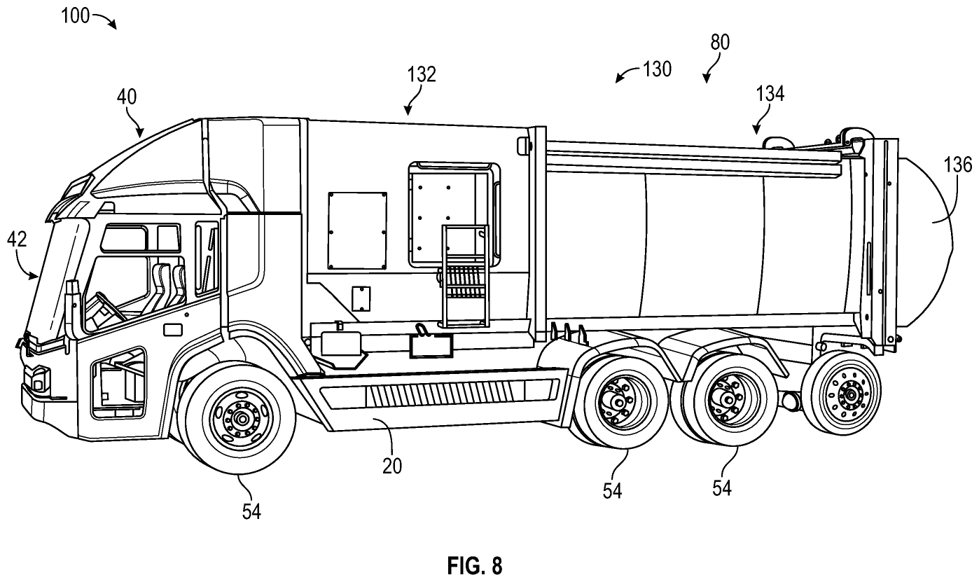

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown, the refuse vehicle 100 of FIGS. 5-7 is configured with a tag axle 90 in FIG. 8.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

### C. Concrete Mixer Truck

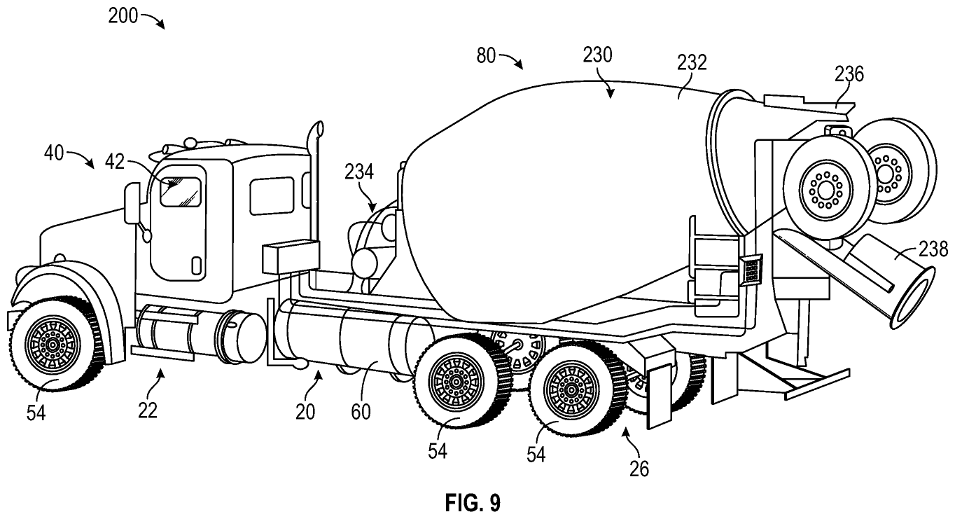

Referring now to FIG. 9, the vehicle 10 is configured as a mixer truck (e.g., a concrete mixer truck, a mixer vehicle, etc.), shown as mixer truck 200. Specifically, the mixer truck 200 is shown as a rear-discharge concrete mixer truck. In other embodiments, the mixer truck 200 is a front-discharge concrete mixer truck.

As shown in FIG. 9, the application kit 80 includes a mixing drum assembly (e.g., a concrete mixing drum), shown as drum assembly 230. The drum assembly 230 may include a mixing drum 232, a drum drive system 234 (e.g., a rotational actuator or motor, such as an electric motor or hydraulic motor), an inlet portion, shown as hopper 236, and an outlet portion, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 may be elevated from the chassis 20 (e.g., from a horizontal plan extending along the chassis 20) at an angle in the range of five degrees to twenty degrees. In other embodiments, the central, longitudinal axis may be elevated by less than five degrees (e.g., four degrees, etc.). In yet another embodiment, the mixer truck 200 may include an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves) including an injection valve that selectively fluidly couples a supply of fluid to the inner volume of the mixing drum 232. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) may be positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 may also include an actuator positioned such that the chute 238 may be selectively pivotable to position the chute 238 (e.g., vertically, laterally, etc.), for example at an angle at which the mixture is expelled from the mixing drum 232.

### D. Fire Truck

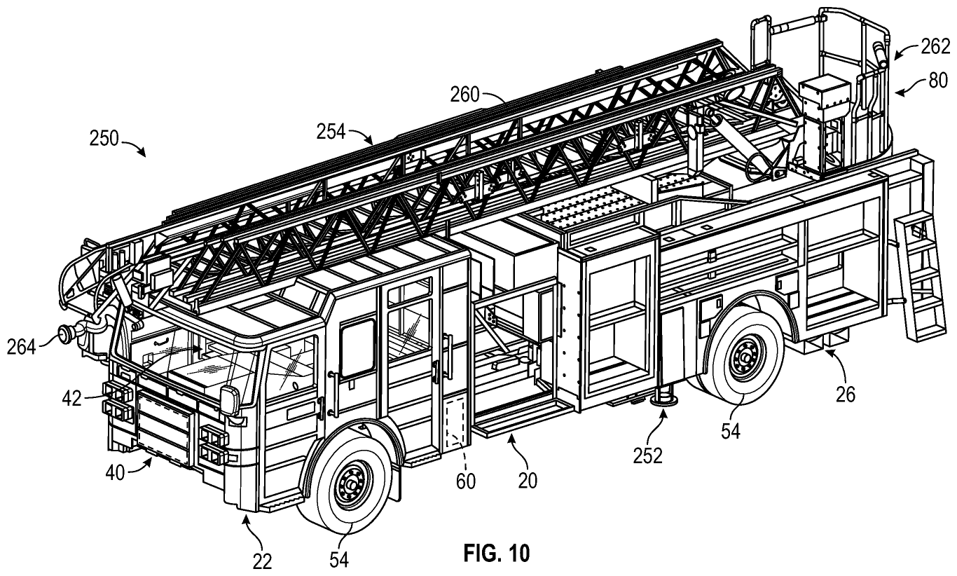

Referring now to FIG. 10, the vehicle 10 is configured as a fire fighting vehicle, fire truck, or fire apparatus (e.g., a turntable ladder truck, a pumper truck, a quint, etc.), shown as fire fighting vehicle 250. In the embodiment shown in FIG. 10, the fire fighting vehicle 250 is configured as a rear-mount aerial ladder truck. In other embodiments, the fire fighting vehicle 250 is configured as a mid-mount aerial ladder truck, a quint fire truck (e.g., including an onboard water storage, a hose storage, a water pump, etc.), a tiller fire truck, a pumper truck (e.g., without an aerial ladder), or another type of response vehicle. By way of example, the vehicle 10 may be configured as a police vehicle, an ambulance, a tow truck, or still other vehicles used for responding to a scene (e.g., an accident, a fire, an incident, etc.).

As shown in FIG. 10, in the fire fighting vehicle 250, the application kit 80 is positioned mainly rearward from the cab 40. The application kit 80 includes deployable stabilizers (e.g., outriggers, downriggers, etc.), shown as outriggers 252, that are coupled to the chassis 20. The outriggers 252 may be configured to selectively extend from each lateral side and/or the rear of the fire fighting vehicle 250 and engage a support surface (e.g., the ground) in order to provide increased stability while the fire fighting vehicle 250 is stationary. The fire fighting vehicle 250 further includes an extendable or telescoping ladder assembly, shown as ladder assembly 254. The increased stability provided by the outriggers 252 is desirable when the ladder assembly 254 is in use (e.g., extended from the fire fighting vehicle 250) to prevent tipping. In some embodiments, the application kit 80 further includes various storage compartments (e.g., cabinets, lockers, etc.) that may be selectively opened and/or accessed for storage and/or component inspection, maintenance, and/or replacement.

As shown in FIG. 10, the ladder assembly 254 includes a series of ladder sections 260 that are slidably coupled with one another such that the ladder sections 260 may extend and/or retract (e.g., telescope) relative to one another to selectively vary a length of the ladder assembly 254. A base platform, shown as turntable 262, is rotatably coupled to the chassis 20 and to a proximal end of a base ladder section 260 (i.e., the most proximal of the ladder sections 260). The turntable 262 may be configured to rotate about a vertical axis relative to the chassis 20 to rotate the ladder sections 260 about the vertical axis (e.g., up to 360 degrees, etc.). The ladder sections 260 may rotate relative to the turntable 262 about a substantially horizontal axis to selectively raise and lower the ladder sections 260 relative to the chassis 20. As shown, a water turret or implement, shown as monitor 264, is coupled to a distal end of a fly ladder section 260 (i.e., the most distal of the ladder sections 260). The monitor 264 may be configured to expel water and/or a fire suppressing agent (e.g., foam, etc.) from a water storage tank and/or an agent tank onboard the fire fighting vehicle 250, and/or from an external source (e.g., a fire hydrant, a separate water/pumper truck, etc.). In some embodiments, the ladder assembly 254 further includes an aerial platform coupled to the distal end of the fly ladder section 260 and configured to support one or more operators.

### E. ARFF Truck

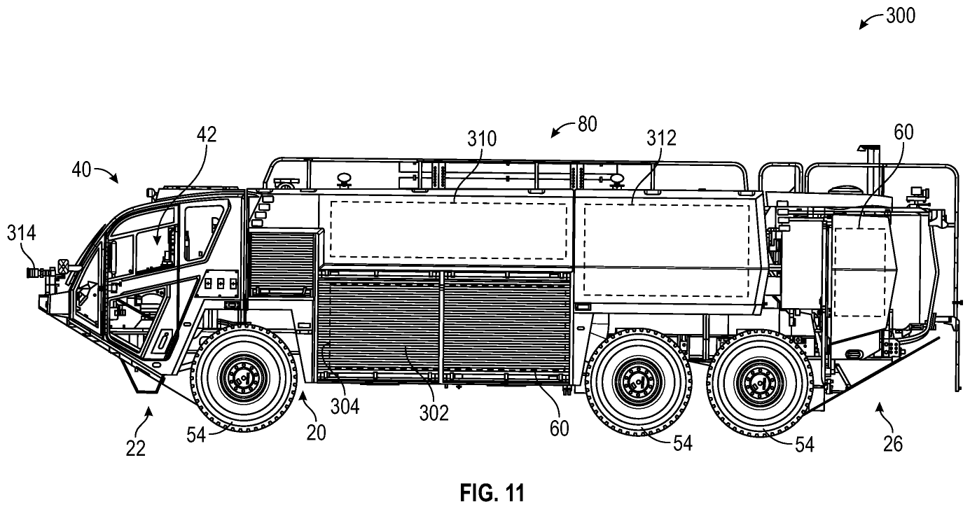

Referring now to FIG. 11, the vehicle 10 is configured as a fire fighting vehicle, shown as airport rescue and fire fighting (ARFF) truck 300. As shown in FIG. 11, the application kit 80 is positioned primarily rearward of the cab 40. As shown, the application kit 80 includes a series of storage compartments or cabinets, shown as compartments 302, that are coupled to the chassis 20. The compartments 302 may store various equipment or components of the ARFF truck 300.

The application kit 80 includes a pump system 304 (e.g., an ultra-high-pressure pump system, etc.) positioned within one of the compartments 302 near the center of the ARFF truck 300. The application kit 80 further includes a water tank 310, an agent tank 312, and an implement or water turret, shown as monitor 314. The pump system 304 may include a high pressure pump and/or a low pressure pump, which may be fluidly coupled to the water tank 310 and/or the agent tank 312. The pump system 304 may to pump water and/or fire suppressing agent from the water tank 310 and the agent tank 312, respectively, to the monitor 314. The monitor 314 may be selectively reoriented by an operator to adjust a direction of a stream of water and/or agent. As shown in FIG. 11, the monitor 314 is coupled to a front end of the cab 40.

### F. Boom Lift

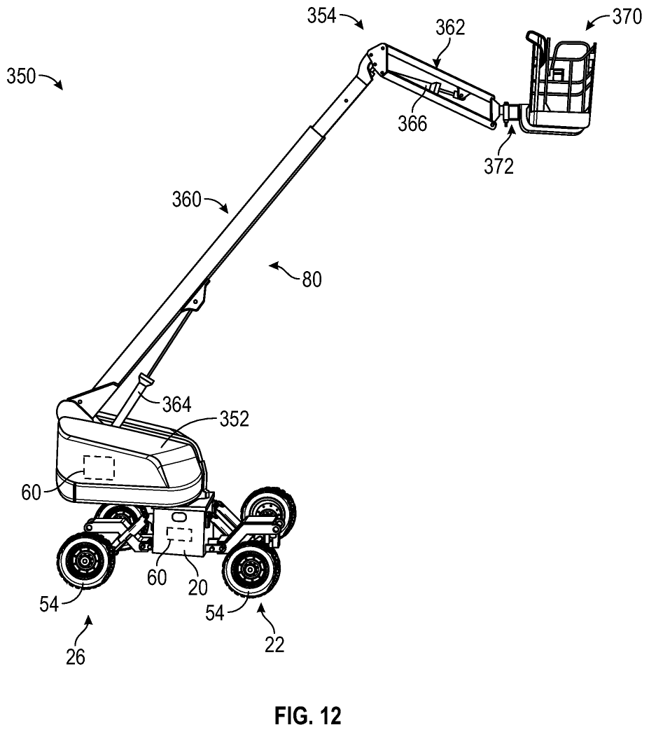

Referring now to FIG. 12, the vehicle 10 is configured as a lift device, shown as boom lift 350. The boom lift 350 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 12, the application kit 80 includes a base assembly, shown as turntable 352, that is rotatably coupled to the chassis 20. The turntable 352 may be configured to selectively rotate relative to the chassis 20 about a substantially vertical axis. In some embodiments, the turntable 352 includes a counterweight (e.g., the batteries) positioned near the rear of the turntable 352. The turntable 352 is rotatably coupled to a lift assembly, shown as boom assembly 354. The boom assembly 354 includes a first section or telescoping boom section, shown as lower boom 360. The lower boom 360 includes a series of nested boom sections that extend and retract (e.g., telescope) relative to one another to vary a length of the boom assembly 354. The boom assembly 354 further includes a second boom section or four bar linkage, shown as upper boom 362. The upper boom 362 may includes structural members that rotate relative to one another to raise and lower a distal end of the boom assembly 354. In other embodiments, the boom assembly 354 includes more or fewer boom sections (e.g., one, three, five, etc.) and/or a different arrangement of boom sections.

As shown in FIG. 12, the boom assembly 354 includes a first actuator, shown as lower lift cylinder 364. The lower boom 360 is pivotally coupled (e.g., pinned, etc.) to the turntable 352 at a joint or lower boom pivot point. The lower lift cylinder 364 (e.g., a pneumatic cylinder, an electric linear actuator, a hydraulic cylinder, etc.) is coupled to the turntable 352 at a first end and coupled to the lower boom 360 at a second end. The lower lift cylinder 364 may be configured to raise and lower the lower boom 360 relative to the turntable 352 about the lower boom pivot point.

The boom assembly 354 further includes a second actuator, shown as upper lift cylinder 366. The upper boom 362 is pivotally coupled (e.g., pinned) to the upper end of the lower boom 360 at a joint or upper boom pivot point. The upper lift cylinder 366 (e.g., a pneumatic cylinder, an electric linear actuator, a hydraulic cylinder, etc.) is coupled to the upper boom 362. The upper lift cylinder 366 may be configured to extend and retract to actuate (e.g., lift, rotate, elevate, etc.) the upper boom 362, thereby raising and lowering a distal end of the upper boom 362.

Referring still to FIG. 12, the application kit 80 further includes an operator platform, shown as platform assembly 370, coupled to the distal end of the upper boom 362 by an extension arm, shown as jib arm 372. The jib arm 372 may be configured to pivot the platform assembly 370 about a lateral axis (e.g., to move the platform assembly 370 up and down, etc.) and/or about a vertical axis (e.g., to move the platform assembly 370 left and right, etc.).

The platform assembly 370 provides a platform configured to support one or more operators or users. In some embodiments, the platform assembly 370 may include accessories or tools configured for use by the operators. For example, the platform assembly 370 may include pneumatic tools (e.g., an impact wrench, airbrush, nail gun, ratchet, etc.), plasma cutters, welders, spotlights, etc. In some embodiments, the platform assembly 370 includes a control panel (e.g., a user interface, a removable or detachable control panel, etc.) configured to control operation of the boom lift 350 (e.g., the turntable 352, the boom assembly 354, etc.) from the platform assembly 370 or remotely. In other embodiments, the platform assembly 370 is omitted, and the boom lift 350 includes an accessory and/or tool (e.g., forklift forks, etc.) coupled to the distal end of the boom assembly 354.

### G. Scissor Lift

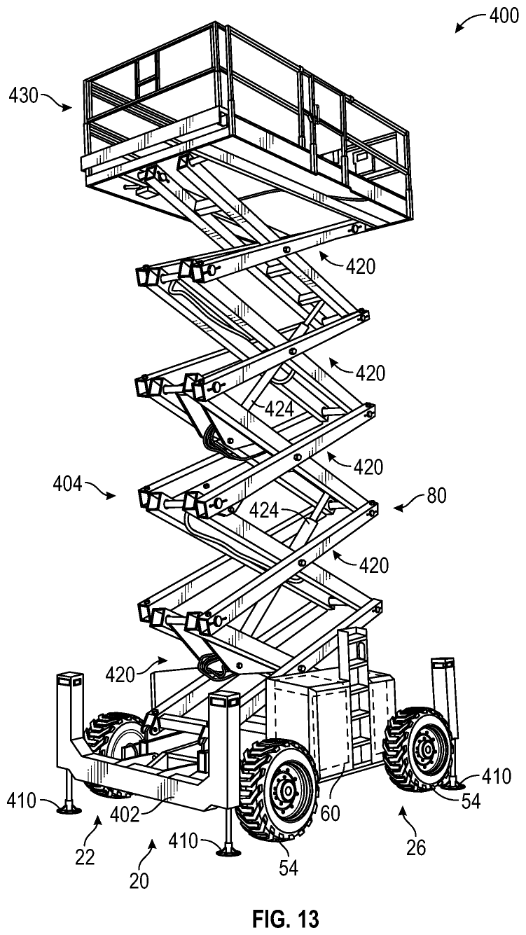

Referring now to FIG. 13, the vehicle 10 is configured as a lift device, shown as scissor lift 400. As shown in FIG. 13, the application kit 80 includes a body, shown as lift base 402, coupled to the chassis 20. The lift base 402 is coupled to a scissor assembly, shown as lift assembly 404, such that the lift base 402 supports the lift assembly 404. The lift assembly 404 is configured to extend and retract, raising and lowering between a raised position and a lowered position relative to the lift base 402.

As shown in FIG. 13, the lift base 402 includes a series of actuators, stabilizers, downriggers, or outriggers, shown as leveling actuators 410. The leveling actuators 410 may extend and retract vertically between a stored position and a deployed position. In the stored position, the leveling actuators 410 may be raised, such that the leveling actuators 410 do not contact the ground. Conversely, in the deployed position, the leveling actuators 410 may engage the ground to lift the lift base 402. The length of each of the leveling actuators 410 in their respective deployed positions may be varied in order to adjust the pitch (e.g., rotational position about a lateral axis) and the roll (e.g., rotational position about a longitudinal axis) of the lift base 402 and/or the chassis 20. Accordingly, the lengths of the leveling actuators 410 in their respective deployed positions may be adjusted to level the lift base 402 with respect to the direction of gravity (e.g., on uneven, sloped, pitted, etc. terrain). The leveling actuators 410 may lift the wheel and tire assemblies 54 off of the ground to prevent movement of the scissor lift 400 during operation. In other embodiments, the leveling actuators 410 are omitted.

The lift assembly 404 may include a series of subassemblies, shown as scissor layers 420, each including a pair of inner members and a pair of outer members pivotally coupled to one another. The scissor layers 420 may be stacked atop one another in order to form the lift assembly 404, such that movement of one scissor layer 420 causes a similar movement in all of the other scissor layers 420. The scissor layers 420 extend between and couple the lift base 402 and an operator platform (e.g., the platform assembly 430). In some embodiments, scissor layers 420 may be added to, or removed from, the lift assembly 404 in order to increase, or decrease, the fully extended height of the lift assembly 404.

Referring still to FIG. 13, the lift assembly 404 may also include one or more lift actuators 424 (e.g., hydraulic cylinders, pneumatic cylinders, electric linear actuators such as motor-driven leadscrews, etc.) configured to extend and retract the lift assembly 404. The lift actuators 424 may be pivotally coupled to inner members of various scissor layers 420, or otherwise arranged within the lift assembly 404.

A distal or upper end of the lift assembly 404 is coupled to an operator platform, shown as platform assembly 430. The platform assembly 430 may perform similar functions to the platform assembly 370, such as supporting one or more operators, accessories, and/or tools. The platform assembly 430 may include a control panel to control operation of the scissor lift 400. The lift actuators 424 may be configured to actuate the lift assembly 404 to selectively reposition the platform assembly 430 between a lowered position (e.g., where the platform assembly 430 is proximate to the lift base 402) and a raised position (e.g., where the platform assembly 430 is at an elevated height relative to the lift base 402). Specifically, in some embodiments, extension of the lift actuators 424 moves the platform assembly 430 upward (e.g., extending the lift assembly 404), and retraction of the lift actuators 424 moves the platform assembly 430 downward (e.g., retracting the lift assembly 404). In other embodiments, extension of the lift actuators 424 retracts the lift assembly 404, and retraction of the lift actuators 424 extends the lift assembly 404.

### Closed-Loop Control for Lift Assembly of Side-Loading Refuse Vehicle

### Operation of Side-Loading Refuse Vehicle

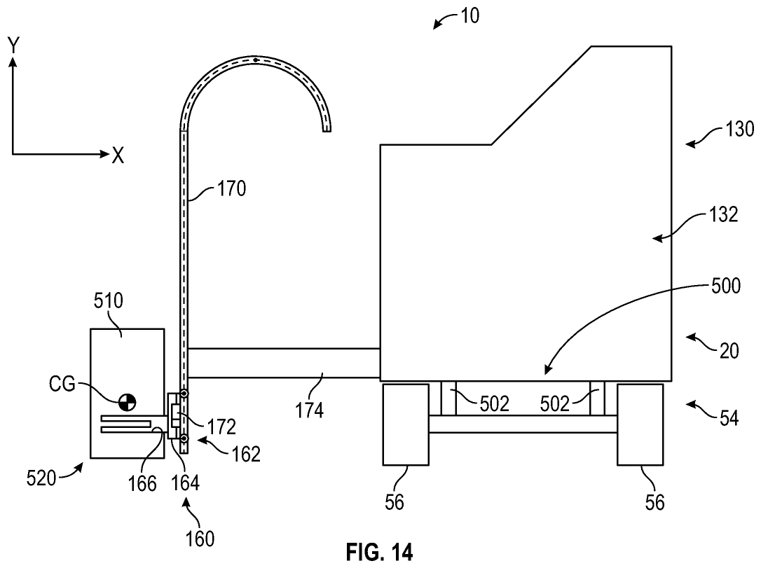

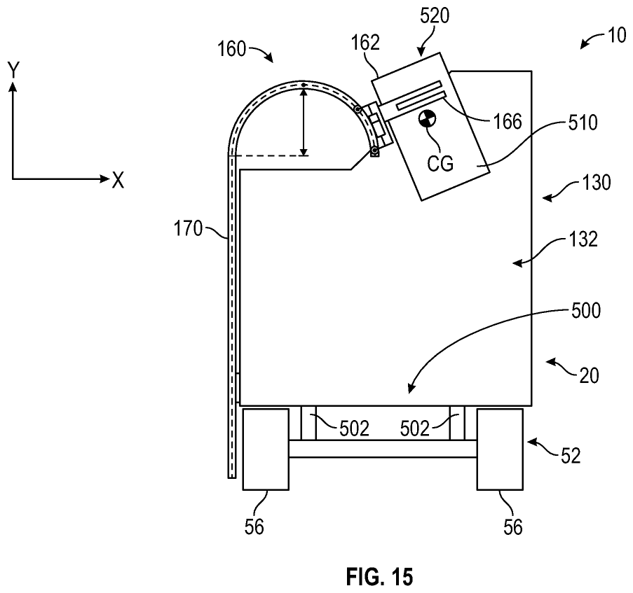

Referring to FIGS. 14 and 15, the side-loading refuse vehicle 100 of FIGS. 5-8 is shown including the lift assembly 160. As shown, the refuse vehicle 100 includes a suspension system, shown as suspension 500, that supports the chassis 20 above the front axle 50 and the rear axles 52. Accordingly, the suspension 500 also supports the components that are coupled to the chassis 20, such as the lift assembly 160, the refuse compartment 130, the cab 40, etc. The suspension 500 includes a series of suspension elements (e.g., springs, dampers, etc.), shown as shock absorbers 502, that each couple the chassis 20 to one or more of the axles (e.g., the front axle 50, the rear axle 52). The suspension 500 may be configured to dissipate vibrations of the chassis 20 relative to the axles. Specifically, the suspension 500 may be primarily configured to dissipate vibrations occurring in a vertical direction.

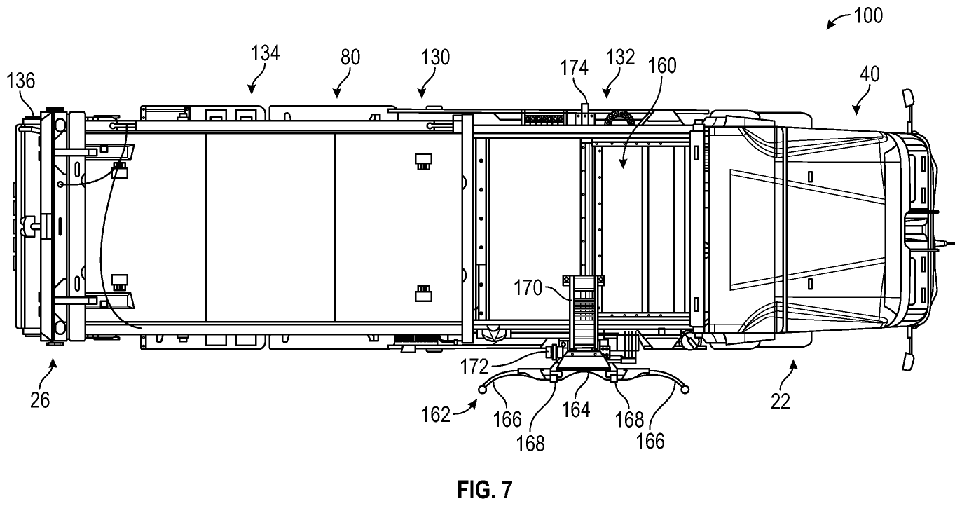

In operation, the grabber assembly 162 engages (e.g., selectively couples to) a refuse container 510 containing a volume of refuse. Specifically, the finger actuators 168 (e.g., as shown in FIG. 7) cause the grabber fingers 166 to rotate inward and engage the refuse container 510. When the grabber fingers 166 are engaging the refuse container 510, the grabber assembly 162, the refuse container 510, and any refuse within the refuse container 510 move together, until the grabber assembly 162 releases the refuse container 510 or the refuse is released (e.g., dumped) from the refuse container 510. The grabber assembly 162, the refuse container 510, and any refuse within the refuse container 510 may be collectively referred to herein as a grabber mass 520. The grabber mass 520 may have a center of gravity CG.

FIGS. 14 and 15 illustrate a range of motion of the grabber mass 520. The grabber mass 520 is moved along the track 170 by the lift actuator 172. The path of the grabber mass 520 when driven by the lift actuator 172 is controlled by the shape of the track 170. The track 170 is generally shaped such that the lift actuator 172 moves the grabber mass 520 vertically. A vertical axis Y is shown in FIGS. 14 and 15 for reference.

The grabber mass 520 and the track 170 is moved laterally (e.g., inward and outward) relative to the chassis 20 by the track actuator 174. Specifically, the track actuator 174 moves the track 170 laterally relative to the chassis 20. The grabber mass 520 is coupled to the track 170, such that the track actuator 174 moves the grabber mass 520 laterally relative to the chassis as well. A lateral axis X is shown in FIGS. 14 and 15 for reference.

FIG. 14 illustrates the grabber mass 520 in a first extreme configuration (e.g., a pickup configuration, an extended position of the track 170). The pickup configuration may represent a condition in which the lift assembly 160 initially engages the refuse container 510. In the pickup configuration, the grabber mass 520 is at a first end of the track 170 (e.g., a pickup end position). Additionally, in the pickup configuration, the track 170 is at a first end of the lateral extension of the track actuator 174 (e.g., a fully extended position). The full extend position may represent the farthest outward position that the track 170 and the track actuator 174 are capable of reaching.

FIG. 15 illustrates the grabber mass 520 in a second extreme configuration (e.g., a dumping configuration). The dumping configuration may represent a condition in which the lift assembly 160 dumps the refuse from the refuse container 510. In the dumping configuration, the grabber mass 520 is at a second end of the track 170 (e.g., a dumping end position). Additionally, in the dumping configuration, the track 170 is at a second end of the lateral extension of the track actuator 174 (e.g., a fully retracted position). The full retract position may represent the closest inward position that the track 170 and the track actuator 174 are capable of reaching.

In operation, the grabber mass 520 moves from the pickup configuration to the dumping configuration to dump the refuse into the hopper volume 132. The grabber mass 520 (which has been reduced due to the loss the refuse) then returns to the pickup configuration before the grabber assembly 162 releases the refuse container 510. This process may be repeated for additional refuse containers 510 as desired.

In moving the grabber mass 520 from the pickup configuration to the dumping configuration, the grabber mass 520 and the track 170 move laterally inward until reaching the full retract position. Upon reaching the full retract position, the track 170 and the grabber mass 520 stop suddenly, resulting in a first impact or slam. The grabber mass 520 moves along the track 170 until reaching the dumping end position. Upon reaching the dumping end position, the grabber mass 520 stops suddenly, resulting in a second impact or slam. Both of these impacts generate vibrations throughout the refuse vehicle 100. If these vibrations reach the operator, they can disturb the operator and reduce operator comfort. An operator is likely to empty many refuse containers 510 on a single route, so this inconvenience can happen frequently and significantly reduce the quality of the user experience of the refuse vehicle 100.

### Control System

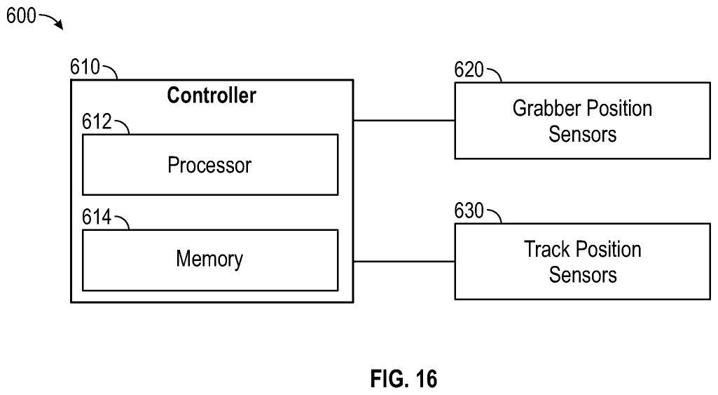

Referring to FIG. 16, the refuse vehicle 100 includes a control system 600 that is configured to improve the user experience by reducing the quantity and/or severity of the impacts experienced by an operator when emptying a refuse container. The control system 600 includes a processing circuit, shown as controller 610, that is configured to control the operation of the lift assembly 160. The controller 610 includes a processor 612 and a memory device, shown as memory 614. The memory 614 may store instructions that, when by the processor 612, cause the controller 610 to perform the processes described herein.

The controller 610 may be operatively coupled to the finger actuators 168, the lift actuator 172, and the track actuator 174. The controller 610 may control the finger actuators 168 to open and/or close the grabber fingers 166. The controller 610 may control the lift actuator 172 to move the grabber assembly 162 along the track 170. The controller 610 may control the track actuator 174 to extend and/or retract the track 170 (i.e., move the track 170 laterally outward and/or laterally inward).

The control system 600 includes sensors that provide positional feedback to facilitate closed-loop control over the position of the lift assembly 160. The control system 600 includes one or more position sensors, shown as grabber position sensors 620, that are operatively coupled to the controller 610. The grabber position sensors 620 are configured to provide first position data (e.g., grabber position data) that indicates a position of the grabber assembly 162 relative to the track 170. The controller 610 may utilize the grabber position data to determine where along the track 170 the grabber assembly 162 is positioned (e.g., and therefore the position of the grabber mass 520).

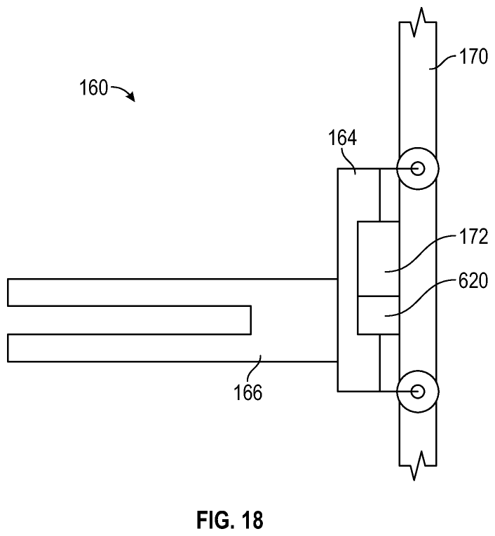

In some embodiments, the grabber position sensors 620 are configured to provide continuous measurements of the position of the grabber assembly 162. By way of example, the control system 600 may include one grabber position sensor 620 that continuously monitors the position of the grabber assembly 162. In some embodiments, such as the embodiment shown in FIG. 18, the grabber position sensor 620 is coupled to the main body 164 such that the grabber position sensor 620 moves with the main body 164 along the track 170. In some embodiments, the grabber position sensor 620 includes a rotary position sensor (e.g., an encoder, a potentiometer, etc.) that is coupled to the main body 164 and the lift actuator 172 and configured to measure movement (e.g., rotation) of the lift actuator 172. The relationship between the number of rotation of the lift actuator 172 and linear movement of the main body 164 along the track 170 may be predetermined and stored in the memory 614. The direction and amount of movement of the lift actuator 172 may be used to determine the current position of the grabber assembly 162. Examples of other grabber position sensors 620 that continuously monitor the position of the grabber assembly 162 include linear potentiometers and/or encoders, cameras with image tracking, or other types of sensors.

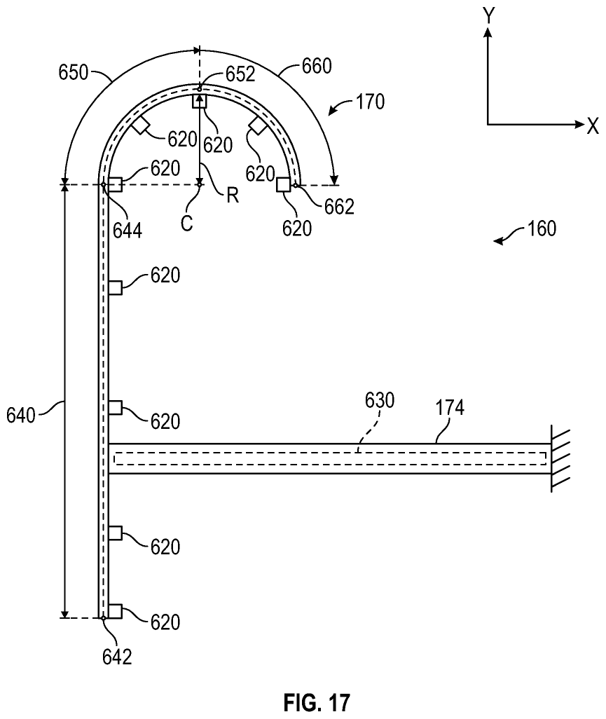

In some embodiments, the grabber position sensors 620 are configured to provide discreet indications of the position of the grabber assembly 162. In some embodiments, such as the embodiment shown in FIG. 17, the control system 600 includes grabber position sensors 620 at multiple different locations along the length of the track 170. Each grabber position sensor 620 may provide an indication when the grabber assembly 162 is nearby, and the controller 610 may determine the position of the grabber assembly 162 based on which grabber position sensors 620 are activated. Examples of such grabber position sensors 620 may include (a) hall effect sensors that identify the presence of a magnet on the main body 164, (b) limit switches that contact the main body 164, (c) proximity sensors that detect when the main body 164 is nearby, or (d) other types of sensors. The control system 600 may include both rotation sensors 620 coupled to the track 170 (e.g., as shown in FIG. 17) and rotation sensors 620 coupled to the main body 164 of the grabber assembly 162 (e.g., as shown in FIG. 18).

The control system 600 includes one or more position sensors, shown as track position sensors 630, that are operatively coupled to the controller 610. The track position sensors 630 are configured to provide second position data (e.g., track position data) that indicates a position of the track 170 relative to the chassis 20. The controller 610 may utilize the track position data to determine the lateral position of the track 170 (e.g., and therefore the position of the grabber mass 520).

In some embodiments, the track position sensors 630 are configured to provide continuous measurements of the position of the track 170. By way of example, the control system 600 may include one track position sensor 630 that continuously monitors how far the track actuator 174 is extended. Examples of such grabber position sensors 620 may include a potentiometer, encoder, or linear variable differential transformer coupled to the track actuator 174.

In other embodiments, the track position sensors 630 are configured to provide discreet indications of the location of the position of the track 170. Examples of such track position sensors 630 may include hall effect sensors, limit switches that contact the main body 164, proximity sensors, or other types of sensors.

Referring to FIG. 17, the track 170 and the track actuator 174 are shown according to an exemplary embodiment. The track 170 includes a series of sections that are connected to one another in series to form a continuous path for the grabber assembly 162. A first section, vertical section, or bottom end portion of the track 170, shown as straight section 640, is straight and substantially vertical. The straight section 640 extends from a bottom end point 642 to a top end point or tangent point, shown as vertical transition point 644. The bottom end point 642 is an end of the track 170 and is the lowermost point on the track 170.

A second section of the track 170, shown as curved quadrant 650, is directly coupled to and continuous with the straight section 640. The curved quadrant 650 extends from the vertical transition point 644 to a tangent point, shown as horizontal transition point 652. The curved quadrant 650 is curved and extends upward and laterally inward from the vertical transition point 644. Specifically, the curved quadrant 650 has a radius of curvature R that is centered about a center of curvature C. In some embodiments, the curved quadrant 650 includes approximately 90 degrees of curvature, such that the curved quadrant 650 forms a quarter circle about the center of curvature C.

A third section of the track 170, shown as curved quadrant 660, is directly coupled to and continuous with the curved quadrant 650. The curved quadrant 660 extends from the horizontal transition point 652 to a tangent point, shown as top end point 662. The curved quadrant 660 is curved and extends downward and laterally inward from the horizontal transition point 652. As shown, the curved quadrant 660 has the same radius of curvature R as the curved quadrant 650 and is centered about the center of curvature C. In some embodiments, the curved quadrant 660 includes approximately 90 degrees of curvature, such that the curved quadrant 660 forms a quarter circle about the center of curvature C.

The movement of the grabber mass 520 follows the shape of the track 170. Along the straight section 640, the entirety of the grabber mass 520 (and thus the center of gravity CG) moves substantially vertically (e.g., collinear with the straight section 640). At the vertical transition point 644, the grabber mass 520 begins moving laterally inward along the curved quadrant 650. When the grabber mass 520 is fully supported by the curved quadrant 650 and/or the curved quadrant 660, the entirety the grabber mass 520 (and thus the center of gravity CG) may move tangent to the curved quadrant 650. At the horizontal transition point 652, the grabber mass 520 moves purely horizontally (e.g., purely laterally inward or laterally outward).

FIG. 17 illustrates one exemplary arrangement of the sensors of the control system 600. A series of grabber position sensors 620 are positioned along the track 170. Each of the grabber position sensors 620 may be configured to provide an indication when the grabber assembly 162 is nearby the grabber position sensor 620. The position of each grabber position sensor 620 may be predetermined and stored in the memory 614 such that the controller 610 can use the grabber position data from the grabber position sensors 620 to determine the current position of the grabber assembly 162 relative to the track 170. A track position sensor 630 is incorporated into the track actuator 174. The track position sensor 630 provides track position data indicating a current extension length of the track actuator 174.

### Impact Reduction by Braking

In some embodiments, the controller 610 is configured to control the lift actuator 172 and/or the track actuator 174 to reduce the speed of the lift assembly 160 prior to an impact. By reducing the speed of the lift assembly 160 before an impact, the intensity of the impact is reduced, and the operator experiences less intense vibration in the cab 40. The lift actuator 172 and/or the track actuator may be used to apply a force (e.g., a braking force) that opposes the current direction of motion of the grabber assembly 162 and/or the track 170. This braking force may reduce the speed of the lift assembly 160 when the impact begins, thereby reducing the severity of the impact. The controller 610 may utilize the grabber position data and/or the track position data to determine when to initiate the braking force.

By way of example, the controller 610 may be configured to control the track actuator 174 to apply a braking force that reduces the intensity of the first impact. When retracting the track 170, the track actuator 174 applies a force on the track 170 in a retracting direction (e.g., laterally inward). The first impact occurs when the track 170 reaches the full retract position and is forced to stop. To reduce the intensity of the first impact, the track actuator 174 applies a force on the track 170 in the extending direction, opposing the current direction of motion of the track 170. This reduces the momentum of the track 170 prior to the first impact occurring, thereby reducing the speed of the track 170 and the kinetic energy that is dissipated during the first impact and the intensity of the vibrations that are transferred to the operator.

In some embodiments, the controller 610 is configured to control the track actuator 174 to being applying the braking force based on the track position data. By way of example, a threshold position may be defined relative to the location of the first impact (e.g., one foot from the location of the first impact, two inches from the location of the first impact, etc.). In some embodiments, the location of the first impact is considered to be the full retract position. The controller 610 may use the track position data to determine when the track 170 has reached the threshold position and initiate the braking force of the track actuator 174 in response to such a determination.

By way of another example, the controller 610 may be configured to control the lift actuator 172 to apply a braking force that reduces the intensity of the second impact. When moving the grabber mass 520 toward the dumping end position, the lift actuator 172 applies a force on the grabber mass 520 that moves the grabber mass 520 in a first direction. The second impact occurs when the grabber mass 520 reaches the dumping end position and the grabber assembly 162 is forced to stop. To reduce the intensity of the second impact, the lift actuator 172 applies a force on the grabber mass 520 in a second direction opposite the first direction. This reduces the momentum of the grabber mass 520 prior to the 520 impact occurring, thereby reducing the kinetic energy that is dissipated during the second impact and the intensity of the vibrations that are transferred to the operator.

In some embodiments, the controller 610 is configured to control the lift actuator 172 to begin applying the braking force based on the grabber position data. By way of example, a threshold position may be defined relative to the location of the second impact (e.g., one foot from the location of the second impact, two inches from the location of the second impact, etc.). In some embodiments, the location of the second impact is considered to be the dumping end position. The controller 610 may use the grabber position data to determine when the lift actuator 172 has reached the threshold position and initiate the braking force of the lift actuator 172 in response to such a determination.

### Simultaneous Impact Occurrence

In some embodiments, the controller 610 is configured to control the lift actuator 172 and/or the track actuator 174 to vary a timing of the first impact relative to the second impact. Specifically, the controller 610 is configured to cause the first impact and the second impact to occur simultaneously (i.e., the track 170 reaches the full retract position and the grabber assembly 162 reaches the dumping end position simultaneously). When both impacts occur simultaneously, the operator experiences fewer impact events (i.e., one or more impacts occurring at a given time), increasing the user experience of the refuse vehicle 10.

When dumping refuse, the lift actuator 172 may move the grabber assembly 162 toward the dumping end position while the track actuator 174 moves the track 170 toward the full retract position. To ensure that the first impact and the second impact occur simultaneously, the controller 610 may vary at least one of (a) a speed at which the lift actuator 172 operates, (b) a speed at which the track actuator 174 operates, or (c) a timing of an operation of the lift actuator 172 relative to an operation of the track actuator 174. By way of example, the controller 610 may speed up or slow down the operation of the lift actuator 172 to vary when the second impact occurs. By way of another example, the controller 610 may speed up or slow down the operation of the track actuator 174 to vary when the first impact occurs. By way of another example, the controller 610 may delay operation of the lift actuator 172 or delay operation of the track actuator 174 to vary a relative timing of the first impact and the second impact.

The controller 610 may utilize feedback from the grabber position sensors 620 and the track position sensors 630 to control the speed and/or timing of the lift actuator 172 and/or the track actuator 174. By way of example, the controller 610 may utilize the grabber position data to determine the current speed and position of the grabber assembly 162. The controller 610 may utilize the track position data to determine the current speed and positon of the track 170. Based on the current speeds and positions of the grabber assembly 162 and the track 170, the controller 610 may estimate a timing at which each impact will occur. The controller 610 may then delay the operation of the lift actuator 172 and/or the track actuator 174 and/or vary the speed of the lift actuator 172 and/or the track actuator 174 to ensure that both impacts occur simultaneously.

### Simultaneous Lateral Movement

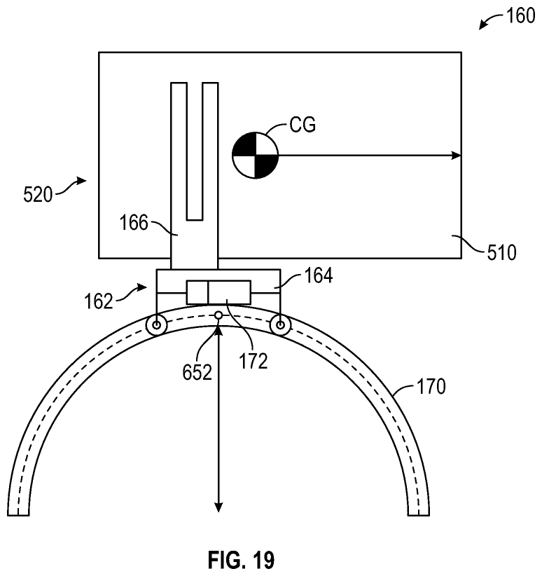

Referring to FIG. 19, the controller 610 may be configured to control the lift actuator 172 and/or the track actuator 174 to cause the first impact to occur while the grabber mass 520 is moving laterally inward (i.e., the track 170 reaches the full retract position while the grabber mass 520 is moving laterally toward the chassis 20 along the curved portion of the track 170). In some such embodiments, the controller 610 causes the first impact to occur while the grabber mass 520 is at the horizontal transition point 652. At the horizontal transition point 652, the grabber mass 520 moves purely laterally (e.g., not vertically).

Timing the first impact to occur while the grabber mass 520 is moving laterally inward may reduce the intensity of the first impact. While the grabber mass 520 moves laterally, the lift actuator 172 applies a lateral force against the track 170. This results in an outward lateral force on the track 170, reducing the inward lateral momentum of the grabber mass 520. This reduces the intensity of the vibrations experienced by the operator during the first impact, improving the user experience. Additionally, the second impact may be primarily directed vertically (e.g., due to the orientation of the curved quadrant 660. The suspension 500 may be more effective at dissipating vibrations from vertical impacts than vibrations from lateral impacts. Accordingly, the second impact may have a lesser negative effect on the user experience than the first impact. By focusing on reducing the intensity of the first impact, the user experience may be improved overall.

When dumping refuse, the lift actuator 172 may move the grabber assembly 162 toward the dumping end position while the track actuator 174 moves the track 170 toward the full retract position. To ensure that the first impact occurs while the grabber mass 520 is moving laterally, the controller 610 may vary at least one of (a) a speed at which the lift actuator 172 operates, (b) a speed at which the track actuator 174 operates, or (c) a timing of an operation of the lift actuator 172 relative to an operation of the track actuator 174. By way of example, the controller 610 may speed up or slow down the operation of the lift actuator 172 to vary when the grabber mass 520 reaches the horizontal transition point 652. By way of another example, the controller 610 may speed up or slow down the operation of the track actuator 174 to vary when the first impact occurs. By way of another example, the controller 610 may delay operation of the lift actuator 172 or delay operation of the track actuator 174 to vary a relative timing of the first impact and when the grabber mass 520 moves laterally along the curved portion of the track 170.

The controller 610 may utilize feedback from the grabber position sensors 620 and the track position sensors 630 to control the speed and/or timing of the lift actuator 172 and/or the track actuator 174. By way of example, the controller 610 may utilize the grabber position data to determine the current speed and position of the grabber assembly 162. The controller 610 may utilize the track position data to determine the current speed and positon of the track 170. Based on the current speeds and positions of the grabber assembly 162 and the track 170, the controller 610 may estimate a timing at which the first impact will occur and a timing when the grabber mass 520 will be traveling laterally around the curved portion of the track 170. The controller 610 may then delay the operation of the lift actuator 172 and/or the track actuator 174 and/or vary the speed of the lift actuator 172 and/or the track actuator 174 to ensure that the first impact occurs while the grabber mass 520 is moving laterally inward.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle comprising:
a chassis;
a body coupled to the chassis and configured to store a volume of refuse;
a lift assembly including:
a track coupled to the chassis;
a track actuator configured to move the track relative to the chassis;
a track position sensor configured to provide track position data indicating a position of the track relative to the chassis;
a grabber coupled to the track and configured to engage a refuse container;
a lift actuator configured to move the grabber relative to the track; and
a grabber position sensor configured to provide grabber position data indicating a position of the grabber relative to the track; and
a controller operatively coupled to the track position sensor and the grabber position sensor and configured to control at least one of (a) the track actuator or (b) the lift actuator based on at least one of (a) the grabber position data or (b) the track position data.

2. The refuse vehicle of claim 1, wherein the controller is configured to vary a speed of the lift actuator based on the grabber position data.

3. The refuse vehicle of claim 2, wherein the controller is configured to reduce the speed of the lift actuator in response to a determination based on the grabber position data that the grabber has reached a threshold position along the track.

4. The refuse vehicle of claim 3, wherein the grabber is movable along the track between a first end position and a second end position, the second end position being above the first end position, wherein the controller is configured to reduce the speed of the lift actuator in response to a determination based on the grabber position data that both (a) the grabber has reached the threshold position along the track and (b) the grabber is moving toward the second end position.

5. The reuse vehicle of claim 2, wherein the grabber is movable along the track between a first end position and a second end position, the second end position being above the first end position, and wherein the controller is configured to reduce the speed of the lift actuator in response to a determination based on the grabber position data that the grabber is moving toward the second end position.

6. The refuse vehicle of claim 1, wherein the controller is configured to vary a speed of the track actuator based on the track position data.

7. The refuse vehicle of claim 6, wherein the controller is configured to reduce the speed of the track actuator in response to a determination based on the track position data that the track has reached a threshold position.

8. The refuse vehicle of claim 7, wherein the track is movable between an extended position and a retracted position, wherein the controller is configured to reduce the speed of the track actuator in response to a determination based on the track position data that both (a) the track has reached the threshold position and (b) the track is moving toward the retracted position.

9. The refuse vehicle of claim 1, wherein the track is movable between an extended position and a retracted position, and wherein the controller is configured to reduce a speed of the track actuator in response to a determination based on the track position data that the track is moving toward the retracted position.

10. The reuse vehicle of claim 1, wherein the controller is configured to vary a timing of an operation of the track actuator relative to a timing of an operation of the lift actuator based on the track position data and the grabber position data.

11. The refuse vehicle of claim 10, wherein the grabber is movable along the track between a first end position and a second end position, the second end position being above the first end position, wherein the track is movable between an extended position and a retracted position, wherein the controller is configured to vary a timing of the grabber reaching the second end position relative to a timing of the track reaching the retracted position based on the track position data and the grabber position data.

12. The refuse vehicle of claim 11, wherein the controller is configured to control the lift actuator to bring the grabber to the second end position and control the track actuator to bring the track to the retracted position at substantially the same time.

13. The refuse vehicle of claim 1, wherein the track includes a straight portion defining a first end position of the grabber and a curved portion defining a second end position of the grabber.

14. The refuse vehicle of claim 13, wherein the track is movable between an extended position and a retracted position, and wherein the controller is configured to control the track actuator to move the track into the retracted position while the grabber is passing along the curved portion of the track.

15. The refuse vehicle of claim 14, wherein the track actuator is configured to move the track laterally between the extended position and the retracted position, wherein the curved portion has a transition point at which the curved portion is tangent to a horizontal plane, and wherein the controller is configured to control the lift actuator and the track actuator such that the grabber reaches the transition point and the track reaches the retracted position at substantially the same time.

16. A method of controlling a refuse vehicle including a chassis, a track movably coupled to the chassis, and a grabber movably coupled to the track and configured to engage a refuse container, the method comprising:
receiving, from a first sensor, track position data indicating a position of the track relative to the chassis;
controlling a track actuator to move the track relative to the chassis based on the track position data;
receiving, from a second sensor, grabber position data indicating a position of the grabber relative to the track; and
controlling a lift actuator to move the grabber relative to the track based on the grabber position data.

17. The method of claim 16, further comprising controlling the track actuator to move the track relative to the chassis based on the grabber position data.

18. The method of claim 16, further comprising controlling the lift actuator to move the grabber relative to the track based on the track position data.

19. The method of claim 16, wherein controlling the track actuator includes reducing a speed of the track relative to the chassis, and wherein controlling the lift actuator includes reducing a speed of the grabber relative to the track.

20. A refuse vehicle comprising:
a chassis;
a body coupled to the chassis and configured to store a volume of refuse;
a lift assembly including:
a track coupled to the chassis;
a track actuator configured to move the track relative to the chassis between an extended position and a retracted position;
a track position sensor configured to provide track position data indicating a position of the track relative to the chassis;
a grabber coupled to the track and configured to engage a refuse container;
a lift actuator configured to move the grabber relative to the track between a lowered position and a raised position; and
a grabber position sensor configured to provide grabber position data indicating a position of the grabber relative to the track; and
a controller operatively coupled to the track position sensor and the grabber position sensor and configured to:
control the track actuator to reduce a speed of the track in response to a determination that the track is within a first threshold distance of the retracted position;
control the lift actuator to reduce a speed of the grabber in response to a determination that the track is within a second threshold distance of the raised position; and
control the track actuator to bring the track to the retracted position and control the lift actuator to bring the grabber to the raised position at substantially the same time.
